(19) United States
(12) Patent Application Publication
(10) Pub. No.: US 2014/0173173 A1
(43) Pub. Date: Jun. 19, 2014

(54) METHOD, DEVICE, AND SYSTEM INCLUDING CONFIGURABLE BIT-PER-CELL CAPABILITY

(71) Applicant: ELPIDA MEMORY, INC., Tokyo (JP)

(72) Inventors: Luca Battu, Pademo d'Adda (IT); Antonino Geraci, Monza (IT); Mauro Pagliato, Bollate (IT); Stefano Surico, Bussero (IT)

(73) Assignee: Elpida Memory, Inc., Tokyo (JP)

(21) Appl. No.: 13/713,921

(22) Filed: Dec. 13, 2012

(51) Int. Cl. G06F 12/02; G06F 12/06

(52) U.S. Cl. CPC G06F 12/0246; G06F 12/06
USPC 711/103; 711/173

(57) ABSTRACT

A method includes providing a partition command to a device that includes a memory array including a plurality of memory cells. In response to the providing of the partition command, the memory cells of the memory array are partitioned to select a portion of the memory array. In response to the providing of the partition command, one of bit numbers that are to be stored in one memory cell is selected, so that each of the memory cells included in the selected portion stores data with the selected one of the bit numbers.

### BACKGROUND OF THE INVENTION

1. Field of the Invention

The present invention generally relates to a method, device, and system for timing control in memory devices. More particularly, a new command for a NAND flash memory permits different portions of the memory to have different bit-per-cell settings.

2. Description of the Related Art

Recent trend analysis show that NAND flash device pervasion within mass storage applications, such as USB (Universal Serial Bus) keys, memory cards, MP3 (MPEG-2 Audio Layer III) players, digital still cameras, mobile phones, solid-state drives, etc., is very large. These many different application scenarios imply several usage models of the device, needs for standardized buses, protocols, and command sets to easily connect this type of memory.

A standard which had been created during the last years and is diffusing more and more is the “eMMC” (embedded MultiMedia Card) standard. This eMMC specification is maintained by JEDEC (Joint Electron Devices Engineering Council), an organization that is a global leader in developing open standards for the microelectronics industry, and is designed to fit well with NAND flash memories within systems. This standard defines a device which incorporates both NAND Flashes and a controller. The protocol, the electrical layer and the package are also defined by the standards body.

Most of the systems currently using this device are aligned to the 4.3 specification of the standard published in November, 2007. Designers are now starting or proceeding to develop products compliant with the 4.4 version (March, 2009) and the 4.41 version (March, 2010). The protocol specification 4.3 (November, 2007) and, even more, the protocol specifications 4.4 (March, 2009), and 4.41 (March, 2010), introduced peculiar features and details for embedded use, making eMMC one of the most interesting memory solutions within mobile and digital consumer platforms.

### SUMMARY OF THE INVENTION

According to a first exemplary embodiment, a method includes providing a partition command to a device that includes a memory array including a plurality of memory cells, partitioning, in response to the providing of the partition command, the memory cells of the memory array to select a portion of the memory array, and selecting, in response to the providing of the partition command, one of bit numbers that are to be stored in one memory cell, so that each of the memory cells included in the selected portion stores data with the selected one of the bit numbers.

According to a second exemplary embodiment, a device includes a first memory array including a plurality of memory cells, a second memory array storing a plurality of bit numbers each of which defines how many bit(s) is to be stored in one memory cell, a controller partitioning, in response to a partition command, the memory cells of the memory array to select a portion of the memory array, and the controller selecting, in response to the partition command, one of the bit numbers stored in the second memory, so that each of the memory cells included in the selected portion of the first memory stores data with the selected bit number.

According to still another exemplary embodiment, a system includes a memory storing data, a controller detecting a type of a storage application to which the memory and the controller are applied, the controller determining, in response to the detecting, a bit number to be stored in one memory cell and the controller further controlling the memory so that the memory stores data with the determined bit number.

### BRIEF DESCRIPTION OF THE DRAWINGS

FIG. 1 shows a NAND flash memory configuration 100 that incorporates an exemplary embodiment of the present invention;

FIG. 1A shows an exemplary NAND flash memory matrix 115;

FIGS. 1B, 1C and 1D show details of an exemplary bit-per-cell configuration of the matrix 115;

FIG. 2 shows an exemplary NAND flash row address 200, incorporating a field identifying a correct number of bits, taking into account the selected bit-per-cell configuration for that address;

FIG. 3 shows exemplary set feature command features and timings 300 of the present invention;

FIG. 4 shows exemplary get feature command features and timings 400 of the present invention;

FIG. 5 shows a configuration 500 of blocks from the NAND device 100 of FIG. 1 that incorporate capabilities and features of an exemplary embodiment of the present invention; and

FIG. 6 shows an exemplary system 600 that demonstrates an exemplary embodiment of the present invention.

### DETAILED DESCRIPTION OF EXEMPLARY EMBODIMENTS OF THE PRESENT INVENTION

One of the features of the aforementioned protocol specifications which have a major impact for a system is “Partition Management”, which enables the capability to split a device into several partitions, each supporting a specific usage model.

In order to address this feature, the present invention provides a solution implemented to support different bit-per-cell storing capability in different portions of a monolithic device.

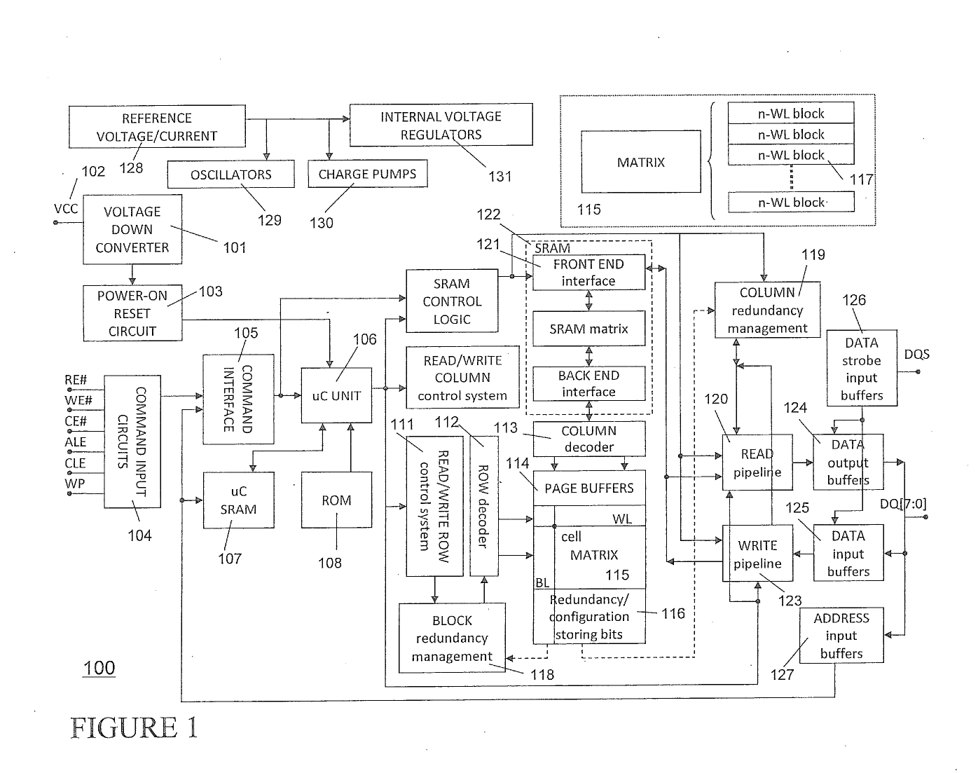

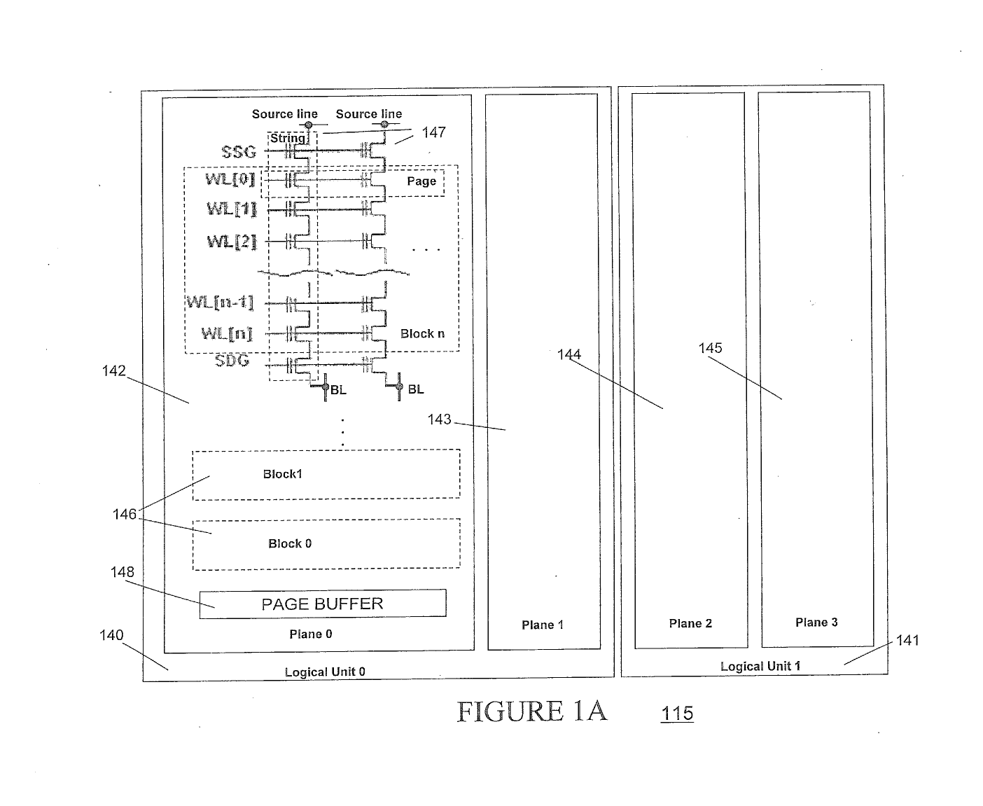

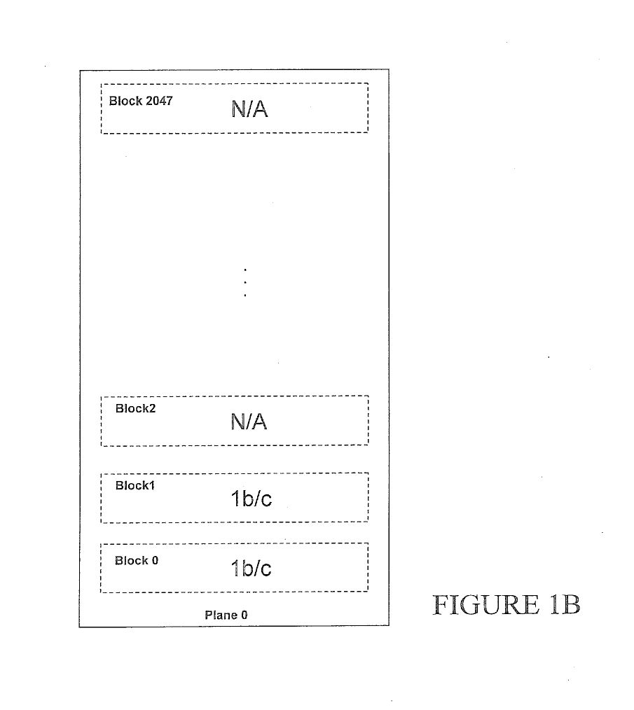

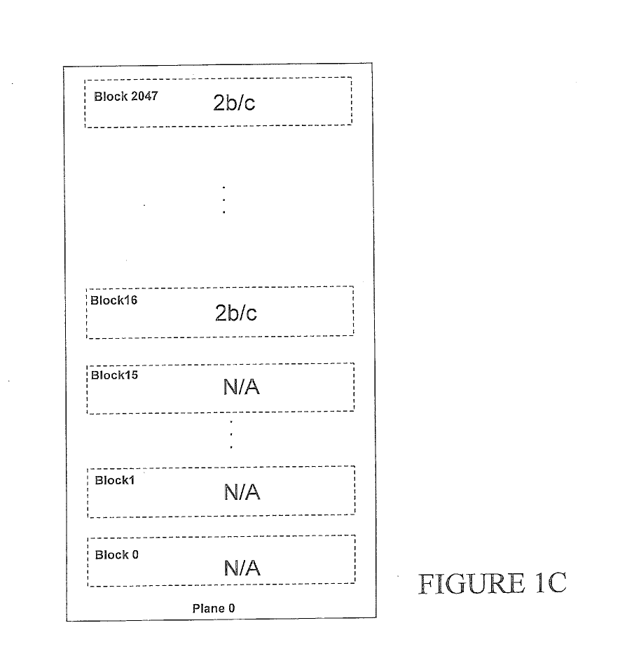

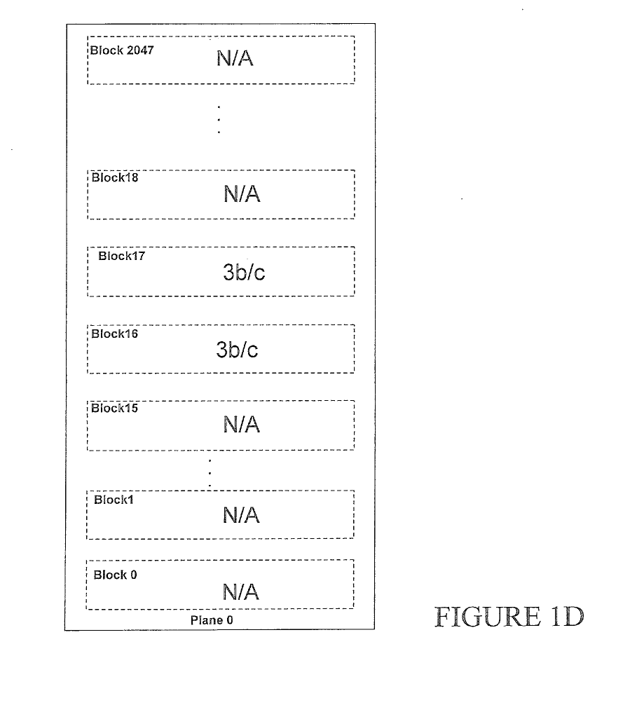

Referring now to the drawings, and more particularly to FIGS. 1-6, exemplary embodiments will now be described.

FIG. 1 shows a NAND flash memory configuration 100 that incorporates an exemplary embodiment of the present invention.

The memory device 100 includes a voltage down converter 101 which is connected to a power supply (VCC) input 102, and a power-on reset circuit 103. The device 100 also includes a command input circuit 104 which is coupled to synchronization pads for receiving a read enable signal (RE#), a write enable signal (WE#), and a chip enable signal (CE#), and is connected to control pads for receiving an address latch enable signal (ALE) and a command latch enable signal (CLE), and is connected to a pad for receiving a write protect signal (WP). The device also includes a command interface 105 which is connected to the command input circuit 104.

The command interface 105 and the power-on reset circuit 103 are connected to a microcontroller unit 106, and a microcontroller RAM 107 and ROM 108 are accessible by the microcontroller unit 106. The device 100 includes SRAM control logic 109 which receives an output of the command interface 105 and the microcontroller unit 106, and also includes read/write column control system 110 and read/write row control system 111 which receive an output of the microcontroller unit 106. The device 100 also includes row decoder 112, column decoder 113, and page buffers 114 which are connected to the matrix (e.g., memory array) 115. The memory array 115 includes redundancy/configuration 116 storing bits and a plurality of memory blocks (e.g., n-WL blocks) 117. The matrix 115 is also connected to block redundancy management 118 and column redundancy management 119.

The device 100 includes a read pipeline 120 which is connected to the column redundancy management 119 and the front end interface 121 of the SRAM 122, and receives an output of the SRAM control logic 109, and an output of the microcontroller unit 106. The device 100 also includes a write pipeline 123 which is connected to the front end interface 121 of the SRAM 122 and receives an output of the SRAM control logic 109 and an output of the microcontroller unit 106. The device 100 also includes data output buffers 124 which receive data which is output of the read pipeline 120 and data input buffers 125 which inputs data to the write pipeline 123. The device 100 also includes data strobe input buffers 126 which are connected to the data output buffers 124 and the data input buffers 125, and address input buffers 127 which input an address to the command interface 105 and the microcontroller SRAM 107. The data output buffers 124, data input buffers 125, data strobe input buffers 126, and address input buffers 127 are connected to data pads (DQ) for inputting data to the device and outputting data from the device.

The device also includes a reference voltage/current generator 128, and oscillators 129, charge pumps 130, and internal voltage regulators 131 which receive an output of the reference voltage/current generator 128.

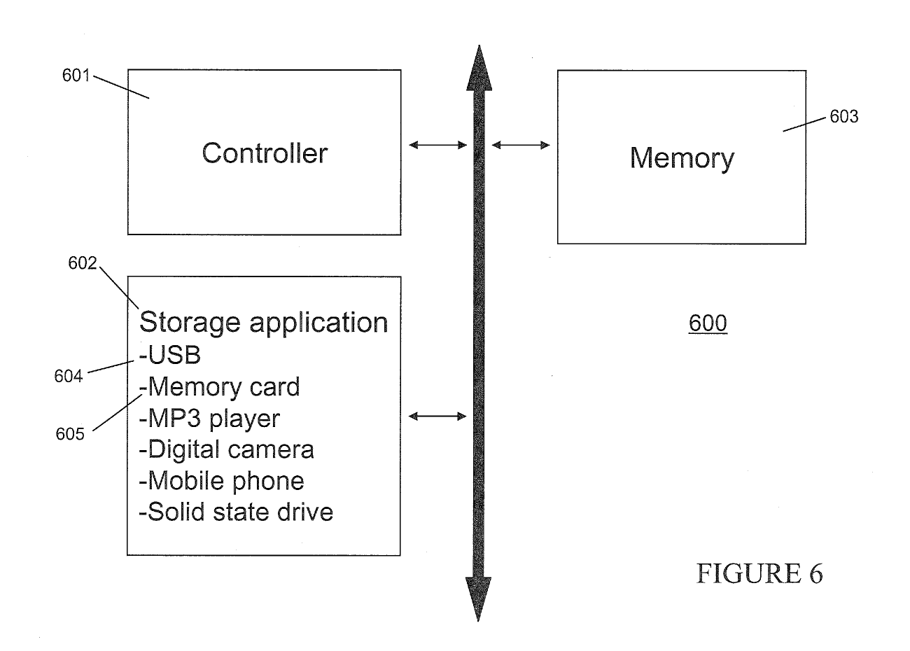

Further, the various signals (e.g., VCC, RE#, WE#, CE#, ALE, CLE, WP and DQ) may be generated by a controller 601 in a system or a digital processing apparatus 600, for example, a memory card, cellular phone as indicated in FIG. 6. For example, the device may be connectable (e.g., fixedly connectable, removably connectable, wirelessly connectable, etc.) to such digital processing apparatus 600 via the pads for receiving VCC, RE#, WE#, CE#, ALE, CLE, WP and DQ, which are illustrated in FIG. 1.

FIG. 1A shows an example of a NAND flash memory array comprising the matrix 115 shown in FIG. 1. This exemplary NAND memory array is organized in logical units 0 and 1 (i.e., 140, 141). A logical unit (LUN) is the minimum unit that can independently execute commands. Separate LUNs may operate on arbitrary command sequences in parallel. The logical unit 0 (i.e., 140) includes plane 0 and 1 (i.e., 142, 143), and the logical unit 1 (i.e., 141) includes plane 2 and 3 (i.e., 144, 145). Each plane is organized in a plurality (number n) of blocks which includes a plurality of strings 147 as shown in FIG. 1A.

Each plane includes a page buffer 148 for its blocks 146. Each string 147 includes a number n of cells in series and two selectors SSG, SSD, one for source side and one for drain side. A multiplicity of strings are connected to the same bit line that is arranged on a first direction and the structure is then repeated on a second direction to reach the full page size, the first and second direction being perpendicular to each other.

A page is the portion of the array addressed at a time for reading and program operations and is structured by a plurality of cells which gates are coupled to one word line. As a result, each memory array is divided in a number N blocks each including at least one string for each bit line. In a few cases, even and odd bit lines can be addressed separately and belong to different pages, but a page is constituted of cells connected by the same word line. Blocks are addressed selectively and represent the minimum area of memory cells to be biased for each erase operation.

Next, the bit-per-cell management is explained. The present invention is based on a dedicated command which sets a NAND device in a defined bit-per-cell (b/c) configuration, freely chosen by the user: 1b/c, 2b/c, 3b/c, 4b/c, . . . , etc. This command relies on existing read/program/erase algorithms actually implemented in the device. Each bit-per-cell configuration has its own specification in terms of timing, cycling, retention, etc. The full NAND Flash array can be impacted by the change or a sub-portion of it, freely chosen by the user.

In one aspect of the present invention, the bit-per-cell configuration selected is applied for any of the following operations (including, but not limited to, Page Read, Page Program, Copyback Program, etc., and their Multi-plane versions). The bit-per-cell configuration that has been previously set is kept until a next coming erase operation is performed in response to issue of a next coming Erase command. It is not possible, for example, to read in a multi-bit-per-cell mode a block that has been previously set in a single-bit-per-cell mode, since the result would be unpredictable. As more specifically explained below, write and read operations are required to be performed the same bit-per-cell configuration as the b/c configuration that has been previously set, so that correct data can be written and then read.

In this view, the conventional NAND Flash has no record of such the bit-per-cell configuration of each block. In such conventional NAND, a bit-per-cell is set as a manufactured product of a NAND Flash device manufacturer. Therefore, a new setting of the bit-per-cell configuration cannot be obtained since the conventional NAND flash product is not configured to change the bit-per-cell configuration for that device.

In contrast to the conventional NAND Flash product, in the present invention, a setting of a bit-per-cell configuration, with its partitioning, is proposed. For example, after power-on, the bit-per-cell configuration is ready to be set and can be set. The bit-per-cell configuration that has been previously set may not be retained after power-off, but it is able to retain the bit-per-cell configuration by storing necessary data for this setting in a non-volatile manner. The bit-per-cell configuration that has been set can be reset in response to reset commands (i.e., Asynchronous Reset: FFh, Synchronous Reset: FCh, Reset LUN: FAh).

### Addressing

In NAND Flashes, there are two address types:
Column Address: used to access bytes or words within a page (i.e., the column address is the byte/word offset into the page); and
Row Address: used to address pages within a block, a plane within a Logical Unit (LUN), blocks within a plane and, in the case of stacked devices, LUNs within a target. Row and Column Addresses are supplied via DQ pins to the interior of a device.

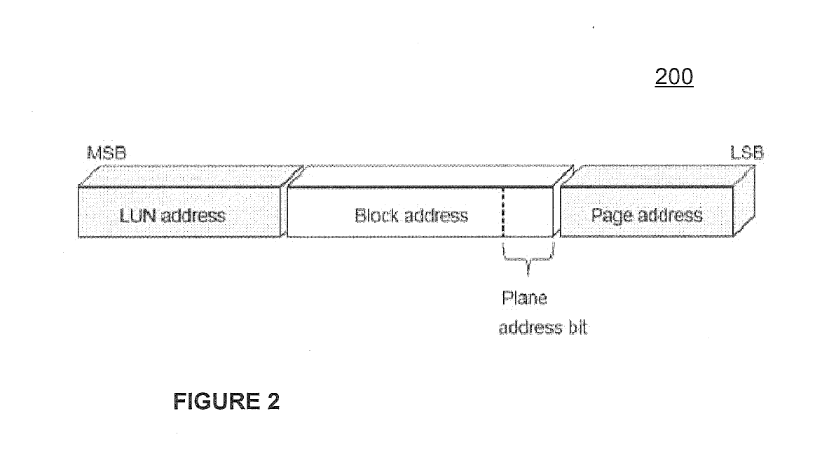

FIG. 2 shows the Row Address structure 200, with the least significant address bit to the right and the most significant address bit to the left. Address information is defined by predetermined bits of information supplied at the DQ pins. LUN to be accessed, block to be accessed, and page to be accessed respectively are addressed by the address information. Write, read, or erase operations can be performed with such address information structure.

Furthermore, in the present invention, the same address information structure can be used to address a target logical unit, block, and page. For example, the target block to be accessed can be configured in different bit-per-cell settings. As explained above, the memory cells are composed in a page of a block (which is addressed by the lower part of the Row Address). The number of such memory cells of a page is determined according to type of memory device product.

In the present invention, the number of bits (i.e. bit-per-cell configuration) stored in one memory cell is chosen depending on the chosen bit-per-cell configuration, so that the total storage capability changes and is determined according to the chosen bit-per-cell configuration.

The NAND Flash host can issue the address with the correct number of bits to the NAND flash memory chip/device, taking into consideration the selected bit-per-cell configuration.

### Exemplary Implementation

In the eMMC v4.41 protocol (JESD84-A441), a Multiple Partition Support is implemented. In Section 7.2 (Partition Management), the following statement is written:
“The embedded device offers also the possibility of configuring by the host additional split local memory partitions with independent addressable space starting from logical address 0x00000000 for different usage models.
Therefore memory block Area can be classified as follows:
   Two Boot Area Partitions, whose size is multiple of 128 KB and from which booting from e•MMC can be performed.
   One RPMB Partition accessed through a trusted mechanism, whose size is defined as multiple of 128 KB.
   Four General Purpose Area Partitions to store sensitive data or for other host usage models and whose size is multiple of a Write Protect Group.
Each of the General Purpose Area Partitions can be implemented with enhanced technological features (such as better reliability*) that distinguish them from the default storage media. If the enhanced storage media feature is supported by the device, boot and RPMB Area Partitions shall be implemented as enhanced storage media by default.”

In view of the above-recited passage from the eMMC protocol, an exemplary embodiment of the present invention can be summarized as follow:
In this eMMC protocol, the memory partitions are introduced. However, there is no direct reference to a particular usage model and specific examples are not introduced. In one aspect of the present invention, new partitions (partition management) with bit-per-cell configuration (bit-per-cell management) can be implemented to enhance technological features. In these partitions, a dedicated usage model for sensitive data should be implemented. The present invention provides a new proposal for a usage model as explained below.
In the ONFI (Open NAND, Flash Interface) Specifications, Vendor Reserved registers are available for a Get-Set Feature command. However, this specification does not introduce a particular usage model. In another aspect, the present invention provides a new proposal for the implementation of the partition usage model (1 bit/c, 2 bit/c, 3 bit/c, 4 bit/c) as explained below at the P1 to P4 implementations.

Therefore, the partition management and the bit-per-cell management of the present invention can be compatible, implemented, and/or used so as to meet the requirements of the eMMC protocol and the ONFI specification.

Next, one exemplary implementation of the present invention is now described for the 32 Gb 32 nm MLC CT-NAND product.

The 32 Gb 32 nm MLC device has the following characteristics:
Page size: 4 KB+224
Block size: 256 pages
Plane size: 2048 blocks
Supports of SLC (1b/c) and MLC (2b/c) mode only
The default bit-per-cell configuration is MLC (2b/c) mode

Next, the ONFI/JEDEC Set/Get Feature command is introduced, as follows. With these characteristics, the address definitions will be the following:

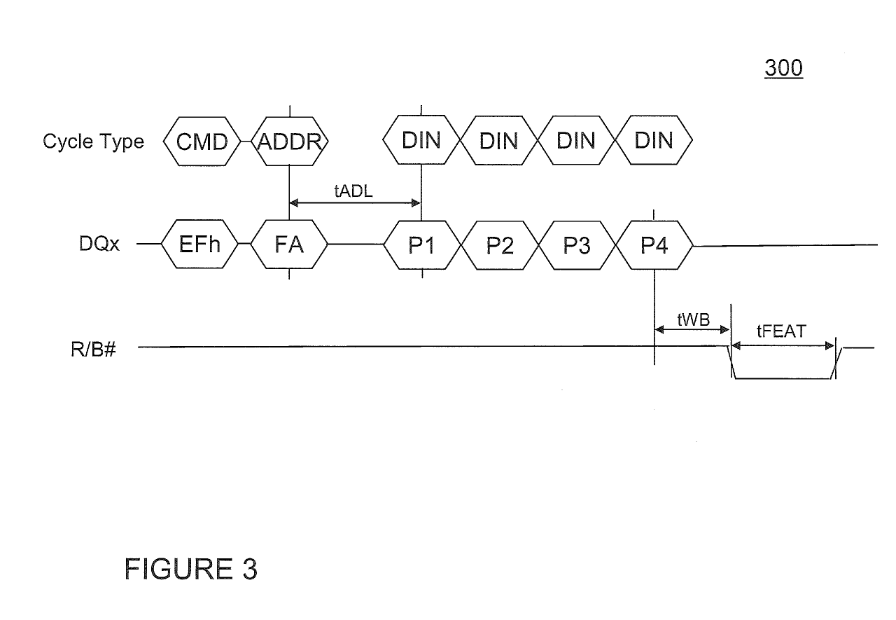

1. The Set Features function is a mechanism that the host uses to modify the settings for a particular feature. The bit-per-cell configuration change is performed with the Set Feature command. FIG. 3 defines the Set Features behavior and timings 300. This timing diagram 300 appears as FIG. 79 of the ONFi (Open NAND Flash interface) specification, which specification also defines the timing periods as follows:
tADL—Address cycle to Data Loading time;
tWB—Clock rising edge; and
tFEAT—Busy time for set FEATure and get FEATure.

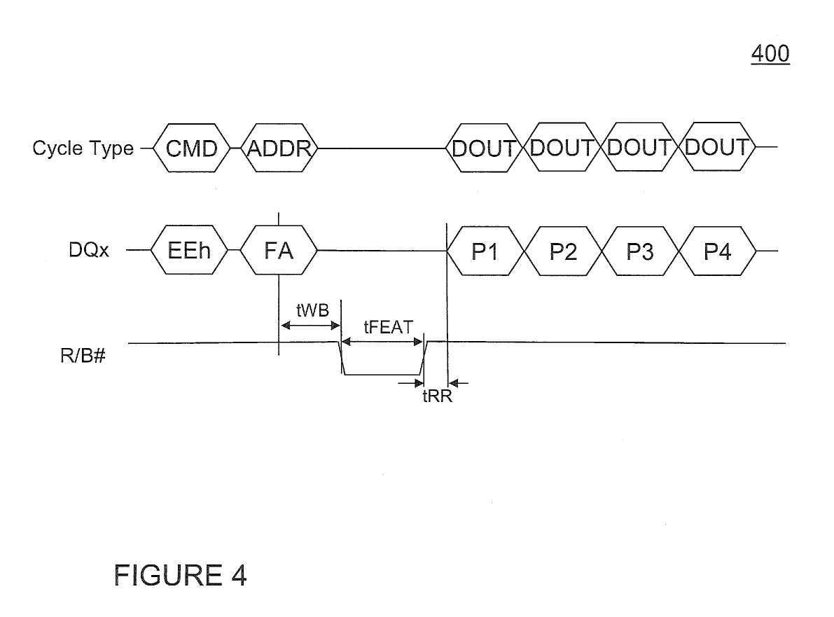

2. The Get Features function is a mechanism that the host uses to determine the current settings for a particular feature. This function returns the current settings for the feature (including modifications that may have been previously made with the Set Features function). FIG. 4 defines the Get Features behavior and timings 400. This timing diagram 400 appears as FIG. 80 of the ONFi specification, which specification also defines the timing periods as follows:
tWB—Clock rising edge;
tFEAT—Busy time for set FEATure and get FEATure; and
tRR—Ready to data output cycle (data only)

In the above-mentioned FIGS. 3 and 4, “FA” is the “Feature Address” identifying the feature to set/get parameters for, while P1 to P4 are the current settings/parameters for the feature identified by argument FA.

Next, the implementation of the present invention here is described:
The chosen Feature Address is “E0h”, which belongs to the ONFI/JEDEC Vendor-specific Feature Address range [80h to FFh];
Sub-feature parameters are used to select the wanted bit-per-cell configuration and the affected part of the memory array, which is the usage model of the present invention:

P1: number of bit-per-cell (see Table 1);

P2: full device vs. portion of device (see Table 2);

P3: starting block address (see Table 3),

It is noted that in this exemplary implementation the “boundary” is expressed as a multiple of [Number_of_Blocks divided by 256 (decimal for FFh)];

P4: number of consecutive blocks (see Table 4),

In this exemplary implementation, blocks are always considered in pairs in order to facilitate Multi-Plane operations on the device.

TABLE 1
An exemplary P1 decoding implementation

| P1 Value | b/c configuration |
|---|---|
| 00h | Reserved |
| 01h | SLC (1b/c) |
| 02h | MLC (2b/c) |
| 03h | TLC (3b/c) |
| 04h | 4b/c |
| 05h . . . FFh | Reserved |

TABLE 2
An exemplary P2 decoding implementation

| P2 Value | LUN partitioning |
|---|---|
| 00h | Full LUN |
| 01h | Block0 and Block1 only |
| 02h | From Block0 included to “Boundary (see P3)” block ex- |
| | cluded |
| 03h | From “Boundary (see P3)” block included to last Block |
| | included |
| 04h | From “Boundary (see P3)” block included for “Number |
| | (see P4)” of consecutive blocks |
| 05h . . . FFh | Reserved |

TABLE 3
An exemplary P3 decoding implementation

| | Boundary | Example 32 Gb MLC 32 nm |
|---|---|---|
| | (multiple of | BLOCK_NUM/FFh = |
| P3 Value | BLOCK_NUM/FFh) | 4096/256 = 16 |
| 00h | BLOCK_NUM/FFh * 0 | 16 * 0 = 0 |
| 01h | BLOCK_NUM/FFh * 1 | 16 * 1 = 16 |
| 02h | BLOCK_NUM/FFh * 2 | 16 * 2 = 32 |
| . . . | . . . | . . . |
| FEh | BLOCK_NUM/FFh * 254 | 16 * 254 = 4064 |
| FFh | BLOCK_NUM/FFh * 255 | 16 * 255 = 4080 |

TABLE 4
An exemplary P4 decoding implementation

| | Number of consecutive |
|---|---|
| P4 Value | blocks (pairs) |
| 00h | 2 blocks |
| 01h | 4 blocks |
| 02h | 6 blocks |
| . . . | . . . |
| FEh | 510 blocks |
| FFh | 512 blocks |

It is noted that it should be clear that the various values in these tables permit a number of possibilities, such as exemplarily defined by various of the attached claims. Turning now to FIGS. 1B, 1C and 1D, the above-explained P1 to P4 values are exemplified. Those figures use the example of the product with plane size: 2048 blocks. A register or a memory may store each value in the implementations of the P1 to P4 tables and each value may be configured to be set and/or selected according to information supplied by host to the Flash device. The information may be the address information as explained in FIG. 2.

FIG. 1B shows an exemplary bit-per-cell configuration of the matrix, for a case 1. In this case 1 example, P1 is 01h (means P1 value indicates 01h in the table) and P2 is 01h (means P2 value indicates 01h in the table).

Block 0 and Block 1 store data with one bit-per-cell, which means each of the memory cells in those blocks stores one bit information and has two threshold distributions such as “0” and “1” values. A write operation and a read operation on the Block 0 and Block 1 are performed with one bit-per-cell configuration. Other blocks 2 to 2047 are not used and not applicable (N/A) in this case.

Since 1 b/c has wider threshold voltage differences than 2b/c and 3b/c, and it has higher reliability than 2b/c and 3b/c, important information, boot information, control information, such information as used for operation another memory areas can be stored in such Block 0 and 1 with high reliability.

FIG. 1C shows an exemplary bit-per-cell configuration of the matrix, for a case 2. In this case 2 example, P1 is 02h (means MLC (2b/c)), and P2 is 03h (means from Boundary block included to last Block included), and P3 is 01h (means 16).

Blocks 16 to 2047 store data with two bits-per-cell, which means each of the memory cells in those blocks stores two-bit information and has four threshold distributions such as “00”, “01”, “10” and “11” values. Other Blocks 1 to 15 are not used and not applicable (N/A) in this case.

FIG. 1D shows an exemplary bit-per-cell configuration of the matrix, for a case 3. In this case 3 example, P1 is 03h (means TLC (3b/c)), and P2 is 04h (means from Boundary block included for “Number” of consecutive blocks), and P3 is 01h (means 16), and P4 is 00h (means 2 blocks).

Blocks 16 and 17 store data with three bits-per-cell which means each of the memory cells in those blocks stores three bit information and has eight threshold distributions such as “000”, “001”, “010”, “011”, “100”, “101”, “110”, and “111” values. Blocks 0 to 15 and Blocks 18 to 2047 are not used and not applicable in this case.

In another aspect, it can be chosen as the combination of the above cases such that blocks 0 and 1 are with one bit-per-cell configuration, and blocks 16 and 17 are with three bits-per-cell.

In still another aspect, if the product has two planes sizes 4096 blocks, it can be chosen with wider blocks sizes than one plane 2048 blocks. For example, P3 is FFh (means 4080) and P4 is 02h (means 6 blocks). Also, P3 is 02h (means 32) and P4 is FFh (means 521 blocks).

In still another aspect, since the page access is applicable in a NAND flash memory, a boundary can be chosen as a page of the chosen block. In the example that one block has 256 pages, page 0 and page 1 of the block stores data respectively with two bits-per-cell. Other pages 2 to 255 of the block cannot be used, as N/A, and also, as a choice, pages 2 to 255 of the block can be used, for instance, with three bits-per-cell. In this way, several arrangements can be applicable in this invention.

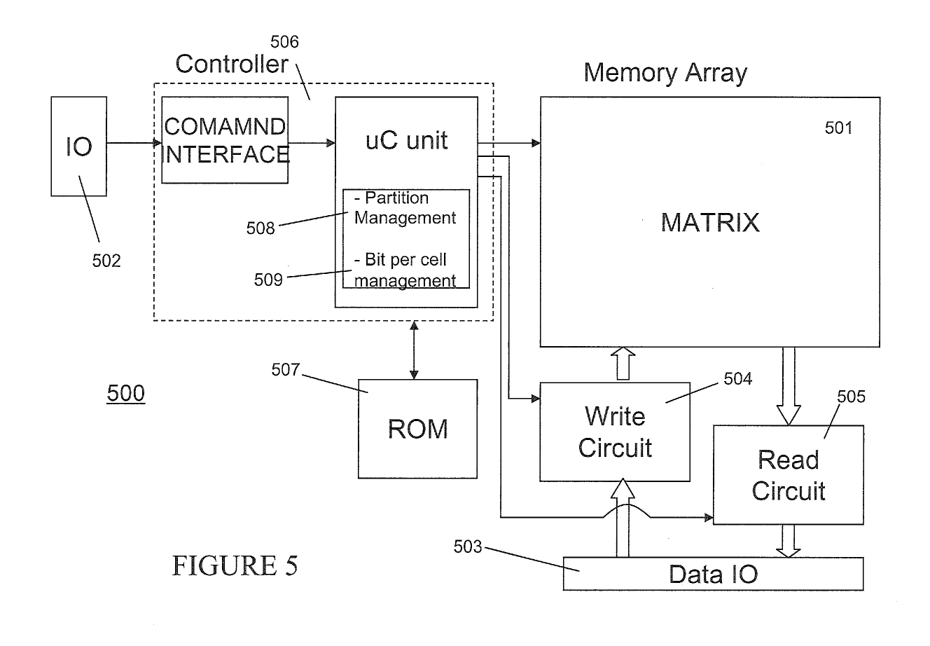

FIG. 5 shows exemplarily a device 500 incorporating the features described above. The blocks shown in FIG. 5 correspond to like blocks shown in FIG. 1, such that, for example, matrix block 501 corresponds to matrix block 16. IO block 502 includes the command input circuits 3 receiving the control signals, such as RE# through WP shown in FIG. 1. Data IO block 503 includes DQ[7:0] and DQS in FIG. 1. Write circuit 504 includes the write pipeline 19, data input buffers 21, and address input buffers 23 in FIG. 1. Read circuit 505 includes read pipeline 18 and data output buffers 20 in FIG. 1. The controller block 506 includes the μC unit 5 and command interface 4 shown in FIG. 1.

ROM block 507, corresponding to ROM 7 in FIG. 1, would store instructions to execute the information conveyed by the P1-P4 parameter values, as identified exemplarily in Tables 1-4 above. ROM 507 can store the information corresponding respectively to the bit-per-cell configurations that be applied to each block as shown in FIGS. 1B, 1C and 1D and/or the table information that shows which one of the bit-per-cell configurations (1b/c, 2b/c, 3b/c, . . . ) is set and applied to corresponding one of the blocks of the memory array. In another aspect, ROM 507 may be a register or other type of a memory capable of storing such information in a non-volatile manner or volatile manner

The controller 506 performs the partition management and bit-per-cell management of the present invention. The partition management 508 manages what parts of the memory array are to be used. The part can be a block or a page. The bit-per-cell management 509 manages how many bit(s)-per-cell is to be stored in the selected parts of the memory array 501. The bit-per-cell is 1b/c, 2b/c, and 3b/c and so on.

In the write operation (in response to a write command), the controller 506 receives via DQ pins the address information as indicated by FIG. 2 and thus can recognize which block and page is to be accessed. As explained above, each block can correspond respectively to bit-per-cell information. The information can be stored in the ROM 507 or stored in another memory area. For example, the NAND flash host can get, in response to the get feature command, the current setting of the bit-per-cell configuration that has been previously set in response to the set feature command as explained above. Also, the controller 506 in the flash memory chip/device accesses the ROM 507 that store the bit-per-cell configuration, and thus the controller 506 can recognize the bit-per-cell information corresponding to the block addressed by the address information. Then, the controller 506 controls the write circuit 504. The write circuit writes input data to the addressed block (page) with its corresponding bit-per-cell configuration.

In the read operation (in response to a read command), the controller 506 receives via DQ pins the address information such as indicated by FIG. 2 and thus can recognize which block and page is to be accessed. In similar to the operation as explained in the write operation, the controller 506 can access the ROM 507 and recognizes the bit-per-cell configuration corresponding to the block addressed by the address information. Then, the controller controls the read circuit 505. The read circuit reads data from cells of the addressed block (page) with its corresponding bit-per-cell configuration.

In order to implement operations in SLC (1b/c), MLC (2b/c), and TLC (3b/c) and so on, several writing pulses, write time period, step-up program pulses or the like can be chosen appropriately to perform a write operation, and several reference voltages can be chosen appropriately to perform a read operation.

FIG. 6 exemplarily shows a system 600 of a typical storage application, such as USB, memory card, and so on. When the system is used, the controller 601 detects the type of the storage application 602 to which the memory 603 is applied. Depending on the type, the controller 601 chooses which bit-per-cell configuration should be used for storing data in the memory 603.

For example, when the controller 601 detects the USB application 604, data to be written in the memory 603 or read from the memory 603 is performed with one bit-per-cell. Conversely, when the controller detects the memory card 605 application, data to be written in the memory 603 or read from the memory 603 may be two bits-per-cell. Identification of the storage application 602 may be implemented by grounding one or more control pins on a chip used to implement the system 600.

Also, in general, one bit-per-cell (SLC) may be more suitable to storing data that needs reliability rather than multiple bits-per-cell (MLC). That is, SLC may be robust due to the wider threshold windows of SLC than those of MLC. Thus, a bit number to be used for storing in the memory may be selected, based upon the desired reliability.

While the invention has been described in terms of an exemplary embodiment, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method comprising:
providing a partition command to a device that comprises a memory array including a plurality of memory cells;
partitioning, in response to the providing of the partition command, the memory cells of the memory array to select a portion of the memory array; and
selecting, in response to the providing of the partition command, one of bit numbers that are to be stored in one memory cell, so that each of the memory cells included in the selected portion stores data with the selected one of the bit numbers.

2. The method as claimed in claim 1, wherein the partitioning includes:
selecting one or ones of blocks of the memory array to define the selected portion of the memory array.

3. The method as claimed in claim 2, wherein the selecting of the one or ones of blocks of the memory array includes selecting one of first, second, third, fourth and fifth selections,
the first selection being associated with all blocks of the memory array,
the second selection being associated with block 0 and block 1 of the blocks of the memory array,
the third selection being associated with blocks that are defined by block 0 and a boundary block,
the fourth selection being associated with blocks that are defined by the boundary block and a last block that is positioned in a last one of the blocks included in the memory array, and
the fifth block being associated with blocks that are defined by the boundary block and consecutive blocks.

4. The method as claimed in claim 1, wherein the partitioning includes:
selecting a boundary block to define a starting position of the selected portion of the memory array; and
selecting a number of consecutive blocks to define an ending position of the selected portion of the memory array.

5. The method as claimed in claim 1, wherein the selected portion of the memory array in the partitioning is defined by more than two blocks.

6. The method as claimed in claim 4, wherein the number of the consecutive blocks is in multiples of two.

7. The method as claimed in claim 1, wherein the bit numbers to be stored in one memory cell are one, two, three and four.

8. The method as claimed in claim 1, further comprising:
providing a second command to the device to write data in the memory array or read data from the memory array, the second command being different from the partition command.

9. The method as claimed in claim 8, further comprising:
writing, in response to the providing of the second command, data with the selected bit number from the selected portion of the memory array.

10. The method as claimed in claim 8, further comprising:
reading, in response to the providing of the second command, data with the selected bit number from the selected portion of the memory array.

11. The method as claimed in claim 8, where the partition command is provided to the device before the second command.

12. A device comprising:
a first memory array including a plurality of memory cells;
a second memory array storing a plurality of bit numbers each of which defines how many bit is to be stored in one memory cell; and
a controller partitioning, in response to a partition command, the memory cells of the first memory array to select a portion of the first memory array,
the controller selecting, in response to the partition command, one of the bit numbers stored in the second memory array, so that each of the memory cells included in the selected portion of the first memory array stores data with the selected bit number.

13. The device as claimed in claim 12, wherein the controller performs, in response to a second command, one of write and read operations on the first memory array, the second command being different from the partition command.

14. The device as claimed in claim 12, wherein the second memory array stores a plurality of values,
a first one of said plurality of values associated with all blocks of the first memory array,
a second one of said plurality of values associated with block 0 and block 1 of the blocks of the memory array,
a third one of said plurality of values associated with blocks that are defined by block 0 and a boundary block,
a fourth one of said plurality of values associated with blocks that are defined by the boundary block and a last block that is positioned in a last one of the blocks included in the first memory array, and
a fifth one of said plurality of values associated with blocks that are defined by the boundary block and consecutive blocks.

15. A system comprising:
a memory array storing data; and
a controller detecting a type of a storage application to which the memory array and the controller are applied, the controller determining, in response to the detecting, a bit number to be stored in one memory cell of the memory array, and the controller further controlling the memory array so that the memory array stores data with the determined bit number.

16. The system as claimed in claim 15, wherein the determined bit number is one of one bit per cell and multiple bits per cell.

17. The system as claimed in claim 15, wherein the storage application includes at least one of USB (Universal Serial Bus) keys, a memory card, an MP3 (MPEG-2 Audio Layer III) player, a digital camera, a mobile phone, and a solid state drive.

18. The system as claimed in claim 15, wherein the memory array comprises a NAND memory.

19. The system as claimed in claim 18, wherein the NAND memory comprises a NAND flash memory.
